(19) United States
(12) Patent Application Publication
(10) Pub. No.: US 2014/0027365 A1
(43) Pub. Date: Jan. 30, 2014

(54) PORTABLE FILTRATION WATER BOTTLE

(71) Applicant: TSUNG-HUI LEE, Taoyuan City (TW)

(72) Inventor: TSUNG-HUI LEE, Taoyuan City (TW)

(21) Appl. No.: 13/558,343

(22) Filed: Jul. 26, 2012

(51) Int. Cl. B01D 35/30

(52) U.S. Cl. 210/232

(57) ABSTRACT

A portable filtration water bottle, comprising: a bottle body having a connection portion at the bottle entrance; and a bottle cap having an opposite connection portion; wherein a protrusion portion having a through hole in the center is set on the bottle cap. Two opposite sides of the periphery of the protrusion portion are set with two axial bodies respectively, wherein the axial bodies are pivoted with a curved cover. And, the central through hole of the protrusion portion is inserted with a soft tube which has a filtration element set in the other end. By this configuration, a user can safely drink with ease through the filtration by the filter when sucking to draw out the beverage contained in the bottle body.

### TECHNICAL FIELD OF THE INVENTION

The present invention relates to a portable filtration water bottle which can make the user drink more safely with ease, and more particularly, to the vessel carried drinking water with a straw or similar structure.

### DESCRIPTION OF THE PRIOR ART

Nowadays, the demand of people for drinking water is no longer just for drinking but further emphasizes the cleanliness and sanitation of water itself. Therefore, the water-cleaner is often used in daily life to filter the impurities of water; especially the public place is needed to set with a large-sized water-cleaning equipment. However, the water-cleaner and the water-cleaning equipment are normally large-sized and have fixed positions such as the ground or the wall. And, they are normally connected with the faucets so as not able to carry on one's person.

When people go outdoors for the tourism, business trip, or work, they can't know in advance if there is clean water to drink or not in that place. Even though the public place has the large-sized water-cleaning equipment, it has no assurance that the public water-cleaning equipment has regular cleaning and maintenance. Who can tell the supplied water is clean and sanitized or not? Consequently, there are many people buying the bottled water to drink. However, besides the high cost, the empty bottle is a resource waste. Furthermore, there are many brands of the bottled water which differ a lot in their quality so as not to guarantee their cleanliness and sanitation of the drinking water.

In view of this, the inventor of the present invention applied a patent application “COMPOUND SPORTS WATER BOTTLE” (application Ser. No.: 13/197,727) which is under examination in the USPTO presently. It has the function and effect of further filtration for drinking water, which can make the user drink more safely with ease. However, the form of the water bottle in the above-mentioned patent application is sports water bottle which filtration element can't be combined with an ordinary water bottle. To overcome this advantage, the inventor invents the present invention, the portable filtration water bottle which can make the user drink more safely with ease, through continuous research, design, and test to provide for the vast public consumer.

### SUMMARY OF THE INVENTION

The major objective of the present invention is to provide a portable filtration water bottle with filtration function which can make the user drink more safely with ease.

To achieve the objective mentioned above, the portable filtration water bottle of the present invention comprises a bottle body having a connection portion at the bottle entrance; and a bottle cap having an opposite connection portion; wherein a protrusion portion having a through hole in the center is set on the bottle cap. Two opposite sides of the periphery of the protrusion portion are set with two axial bodies respectively, wherein the axial bodies are pivoted with a curved cover. And, the central through hole of the protrusion portion is inserted with a soft tube which has an insertion trench set in the other end to provide to a filtration element for insertion and combination.

The portable filtration water bottle as mentioned above, wherein the opposite connection portion of the bottle cap is further set with a leakproof washer.

The portable filtration water bottle as mentioned above, wherein the periphery of the protrusion portion of the bottle cap is further set with a trench for placing and installing an end portion of the soft tube.

The portable filtration water bottle as mentioned above, wherein the filtration element is selected from any of an activated carbon, a resin, a far-infrared, an energy stone, a ceramic filter, or a combination thereof

The portable filtration water bottle as mentioned above, wherein the filtration element is a one-body form through combining activated carbon with cotton filter and screen.

The portable filtration water bottle as mentioned above, wherein the bottle entrance of the bottle body is circled with a ring which is convenient to take out.

The advantages of the present invention comparing to the conventional techniques are:

1. One end of the soft tube is set with a filtration element which can make the contained beverage filtered once more by the filtration element and thus make the user feel safer with ease when drinking.

2. The water bottle does not just have the function to contain water, but further have the function of filtration.

3. Through the assembly of the filtration element with simple and low-cost configuration, the portable filtration water bottle of the present invention will be more competitive in the market.

### BRIEF DESCRIPTION OF THE DRAWINGS

FIG. 1 is a perspective view of the outlook schematic diagram of the preferred embodiment according to the present invention.

FIG. 2 is an exploded view of the element schematic diagram of the preferred embodiment according to the present invention.

FIG. 3 is an operational schematic diagram of the preferred embodiment according to the present invention.

FIG. 4 is a cross-sectional schematic diagram of the filtration element according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

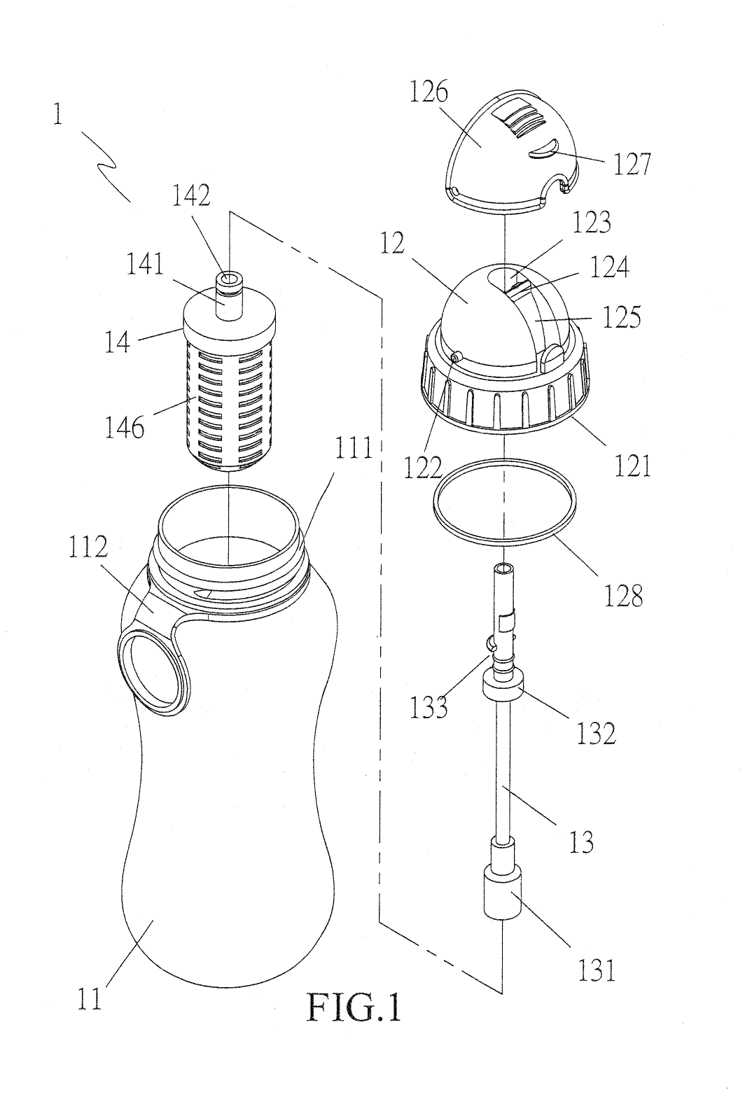

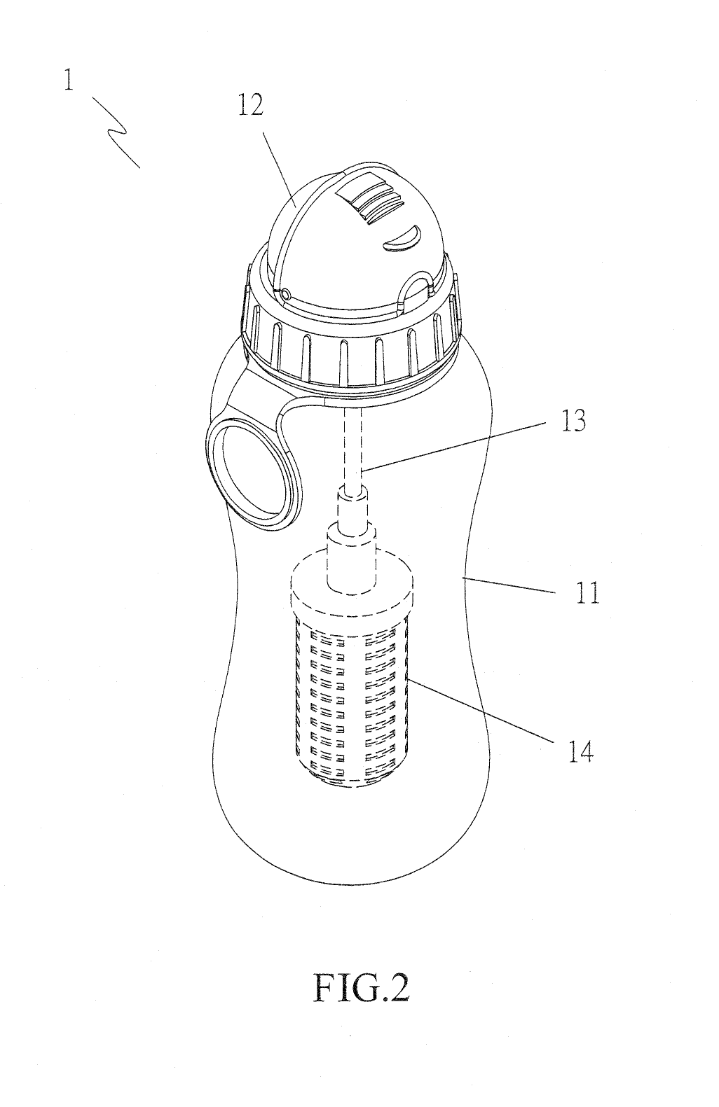

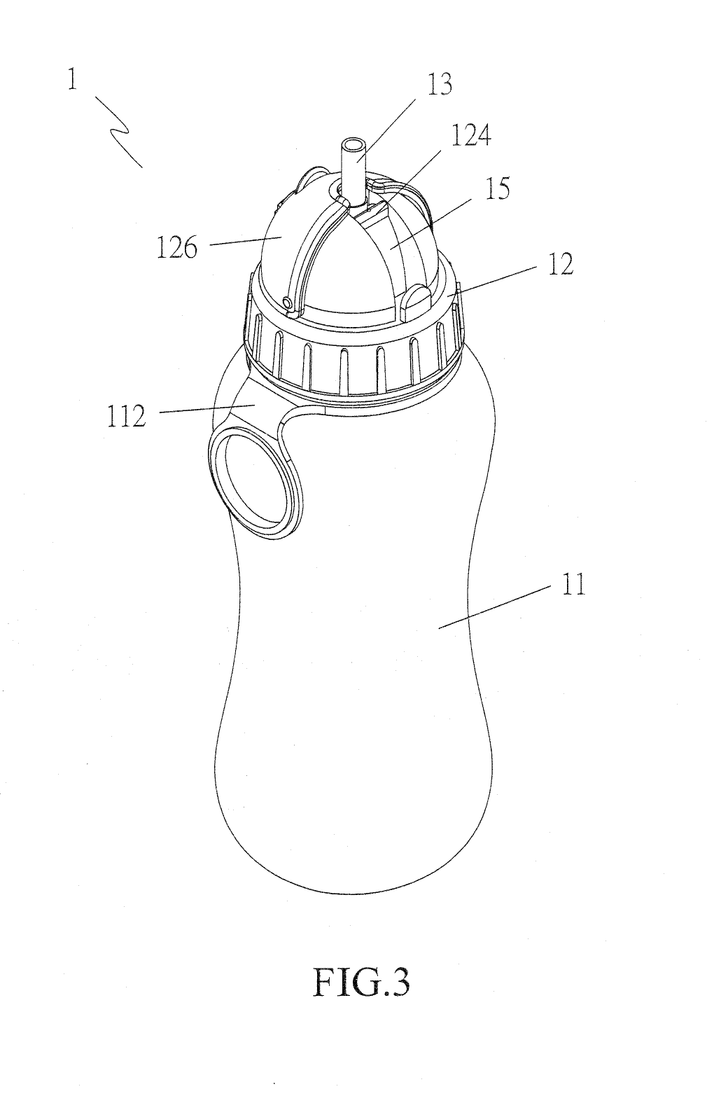

Please refer to FIG. 1 to FIG. 3; the portable filtration water bottle 1 of the present invention comprises a bottle body 11, a bottle cap 12, a soft tube 13, and a filtration element 14. The bottle body 11 is set with inner accommodation space and has threads at the bottle entrance to form a connection portion 111. And, the bottom of the connection portion 111 is circled with a ring 112.

The inner bottom edge of the bottle cap 12 is set with an opposite connection portion 121 to match with the connection portion 111 of the bottle body 11, and a O-shape washer 128 is set inside the opposite connection portion 121. And, a protrusion portion 124 having a through hole 123 in the center is set on the bottle cap 12. Two opposite sides of the periphery of the protrusion portion 124 are set with two axial bodies 122 respectively, wherein the axial bodies 122 are pivoted with a curved cover 126. And, a lift-protrusion portion 127 is set on the curved cover 126.

The soft tube 13 is set with an insertion trench 131 and circled with a moving-stopper 132 near its upper end, and several curved convex slipping-stoppers 133 are set at proper locations upon the moving-stopper 132.

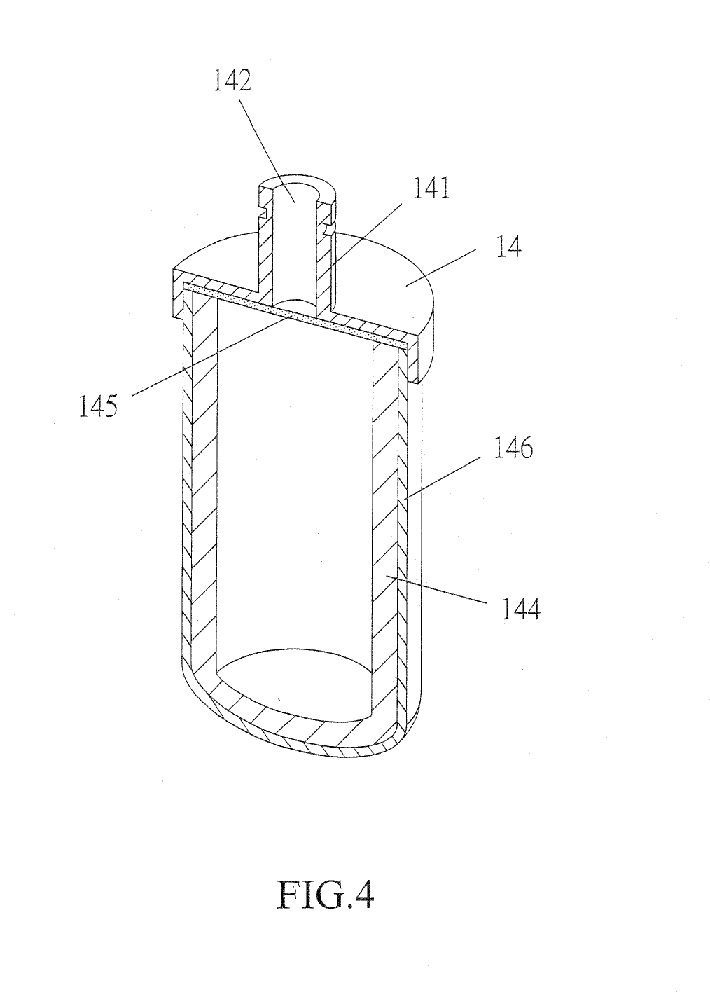

The filtration element 14 is protruded with an inlay portion 141 having a channel 142 inside, wherein the bottom face of the inlay portion 141 is set with the filter cotton 145. And, the screen 146 circled with the activated carbon 144 is combined under the filter cotton 145. The channel 142 is across the filter cotton 145 to combine with the activated carbon 144 as shown in FIG. 4. Further, the filtration element 14 can be selected from any of a resin, a far-infrared, an energy stone, a ceramic filter, or a combination thereof

The filtration element 14 is inserted with the insertion trench 131 of the soft tube 13 to combine into a one-body form via the inlay portion 141. Then, lift the curved cover 126 of the bottle cap 12 via the lift-protrusion portion 127 and place the other end of the soft tube 13 through the central through hole 123 of the bottle cap 12 to make the upper end of the soft tube 13 exposed to the central through hole 123. The slipping-stoppers 133 is slotted inside the central through hole 123, and the moving-stopper 132 is stopped at the bottom of the central through hole 123. When the curved cover 126 is pushed downwardly, the upper end of the soft tube 13 is simultaneously forced by the pushing force of the curved cover 126 and the tugging force of the protruded lateral rod 124 so as to form a bend portion. Then, using the opposite connection portion 121 in the bottom edge of the bottle cap 12 to combine with the connection portion 111 in the top of the bottle body 11 to form a completed portable filtration water bottle 1.

The water solution is filled into the bottle body 11 via the connection portion 111 of the bottle body 11, then the bottle cap 12 is combined with the bottle body 11 to make the filtration element 14 placed into the water solution and thus the water solution is portable. When applying force to the lift-protrusion portion 127 of the curved cover 126 of the bottle cap 12, the curved cover 126 will turn over backward to make the compression force of the soft tube 13 disappear and thus the soft tube 13 will appear in an erective shape to be convenient for being holding in the user's mouth to suck. The sucking force inside the soft tube 13 makes the water solution contained in the bottle body 11 go through and be filtered by different layers of the filtration element 14 which include the screen 146, the activated carbon 144, and the filter cotton 145 and thus the user can safely drink with ease.

I claim:

1. A portable filtration water bottle, comprising: a bottle body having a connection portion at the bottle entrance; and a bottle cap having an opposite connection portion; wherein the portable filtration water bottle is characterized in that:
a protrusion portion having a through hole in the center is set on the bottle cap; two opposite sides of the periphery of the protrusion portion are set with two axial bodies respectively; wherein the axial bodies are pivoted with a curved cover; and the through hole in the center of the protrusion portion is inserted with a soft tube which has an insertion trench in the other end provided for the insertion and combination of a filtration element.

2. The portable filtration water bottle according to claim 1, wherein the opposite connection portion of the bottle cap is further set with a leakproof washer.

3. The portable filtration water bottle according to claim 1, wherein the periphery of the protrusion portion of the bottle cap is further set with a trench for placing and installing an end portion of the soft tube.

4. The portable filtration water bottle according to claim 1, wherein the filtration element is selected from any of an activated carbon, a resin, a far-infrared, an energy stone, a ceramic filter, or a combination thereof

5. The portable filtration water bottle according to claim 1, wherein the filtration element is a one-body form through combining activated carbon with cotton filter and screen.

6. The portable filtration water bottle according to claim 1, wherein the bottle entrance of the bottle body is circled with a ring which is convenient to take out.
